(19) United States
(12) Patent Application Publication
(10) Pub. No.: US 2021/0237152 A1
(43) Pub. Date: Aug. 5, 2021

(54) Method And System For Recycling Metal Products Using QR Codes

(71) Applicant: MolyWorks Materials Corp., Los Gatos, CA (US)

(72) Inventors: Cynthia Doan, Los Gatos, CA (US); CHRISTOPHER P. EONTA, Los Gatos, CA (US); JASON PITTS, San Jose, CA (US); JEFF MclNTIRE, Castro Valley, CA (US); DEVIN MORROW, Santa Rosa, CA (US); ANDREW Vanos LaTOUR, Hayward, CA (US); MATTHEW CHARLES, Cloverdale, CA (US)

(73) Assignee: MolyWorks Materials Corp., Los Gatos, CA (US)

(21) Appl. No.: 16/781,128

(22) Filed: Feb. 4, 2020

(51) Int. Cl. B22F 3/105; B33Y 10/00; B33Y 30/00; B33Y 40/00; B33Y 50/00

(52) U.S. Cl. CPC B22F 3/1055; B33Y 10/00; B22F 2003/1059; B33Y 40/00; B33Y 50/00; B33Y 30/00

(57) ABSTRACT

A method for recycling metal parts includes the steps of providing a metal part with a QR code linked to an online website or an application containing data on the metal part and information on recycling of the metal part. The method also includes the step of reading the QR code using a mobile communication device enabling access to the information on the website or the application by a user of the mobile communication device and access to the data on the metal part by a recycling entity associated with the website or the application. The method also includes the step of displaying selected information from the website or the application on the mobile communication device. The method also includes the step of recycling the metal part using at least some of the information on the website or the application and the data on the metal part.

### FIELD

This disclosure relates to a method and system for recycling metal products using QR codes.

### BACKGROUND

One problem with the recycling of metal products is that it is difficult to get consumers to recycle metal products. For example, consumers are aware of recycling procedures for metal cans but other metal parts are typically not recycled. Metal recycling is often performed by freelance scrap collectors who know how to handle and sell the metal parts discarded by consumers at trash collection sites, such as sidewalks and dumps. There is a need in the art for methods and systems that permit more consumers to recycle metal parts.

It is also difficult to target consumers that are likely to engage in recycling activities. It would be desirable for consumers to have more information on the recycling of metal products, particularly metal products in their possession that are suitable for recycling. In addition, it would be desirable to have the ability to contact these types of consumers for marketing and educational purposes.

This disclosure relates to a method and system for recycling metal products using QR codes that gives consumers access to a recycling protocol and value information on metal parts. In addition, the method and system permits recyclers to identify and target particular consumers with marketing information.

### SUMMARY

A method for recycling metal parts includes the steps of: providing a metal part with a QR code linked to an online website or an application containing data on the metal part and information on recycling of the metal part; reading the QR code using a mobile communication device enabling access to the information on the website or the application by a user of the mobile communication device and access to the data on the metal part by a recycling entity associated with the website or the application; displaying selected information from the website or the application on the mobile communication device; and recycling the metal part using at least some of the information on the website or the application and the data on the metal part. The method can also include the step of manufacturing a recycled metal part using metal from melting of the metal part. In an illustrative embodiment the manufacturing step is performed using an additive manufacturing system. The method can also include the step of contacting the user using contact information obtained from the mobile communication device during the reading step.

A recycling system for recycling metal parts includes a metal part having a QR code containing data on the metal part; a mobile communication device configured to read the QR code and having a link to an online website or an application containing information on recycling the metal part; and a recycling entity configured to control the information, to access the data and to recycle the metal part. In an illustrative embodiment the recycling system also includes an additive manufacturing system configured to melt the metal part into a molten metal, to atomize the molten metal into an alloy powder, and to fabricate a recycled metal part using the alloy powder.

### BRIEF DESCRIPTION OF THE DRAWINGS

Exemplary embodiments are illustrated in the referenced figures of the drawings. It is intended that the embodiments and the figures disclosed herein be to be considered illustrative rather than limiting.

FIG. 1A is a plan view of a metal part having a QR code;

FIG. 1B is a side elevation view of the metal part;

FIG. 2 is a schematic view of a mobile communication device operated by a user during reading of the QR code on the metal part;

FIG. 3 is a schematic view of a display screen of the mobile communication device displaying information on recycling of the metal part along with feedback on the user and the metal part;

FIG. 4 is a schematic view of a system for recycling metal parts;

FIG. 5 is a schematic diagram of a process flow in a method for recycling metal parts and manufacturing recycled metal parts using an additive manufacturing system;

FIG. 6A is a perspective view of the metal part having the QR code prior to melting;

FIG. 6B is a schematic view of a cold hearth mixing system configured for melting the metal part into a molten metal;

FIG. 6C is a schematic view of an atomization system configured for atomizing molten metal obtained from melting of the metal part;

FIG. 6D is a schematic view of an alloy powder obtained from atomizing of the molten metal;

FIG. 7A is a schematic plan view of a recycled metal part having a QR code fabricated using an additive manufacturing process; and

FIG. 7B is an enlarged portion of FIG. 7A illustrating the QR code prior to coloring.

### DETAILED DESCRIPTION

As used herein the term “QR code” means a Quick Response Code in the form of a printed matrix barcode readable by an optical reader.

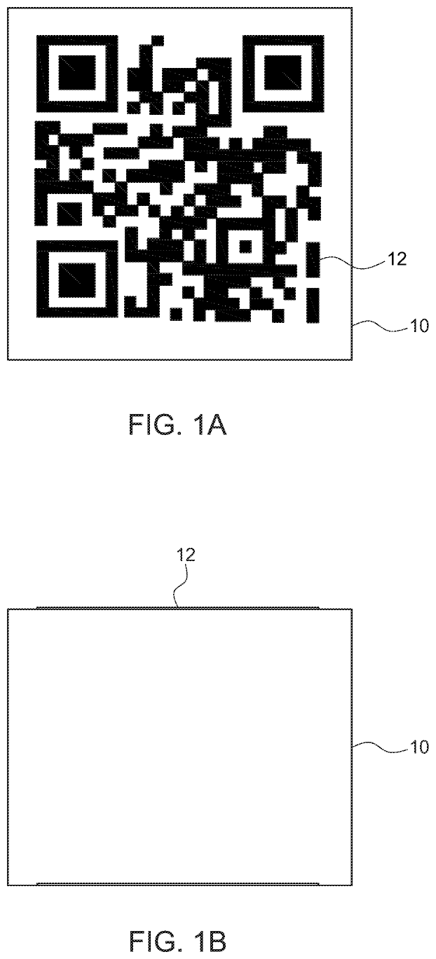

Referring to FIGS. 1A-1B, and FIGS. 2-3, a metal part 10 (FIGS. 1A-1B) includes a QR code 12 (FIG. 1A-1B) linked to an online website 14 (FIG. 3) or an application 16 (FIG. 3) containing data 18 (FIG. 3) on the metal part 10 (FIGS. 1A-1B) and information 20 (FIG. 3) on recycling of the metal part 10 (FIGS. 1A-1B). The data can include logistics, such as how to return the metal part 10 for recycling, manufacturing data on the metal part 10, such as material certifications and process data. The data permits traceability and provides a certified strap stream. In addition, the data can be used to bring an off line metal part on line.

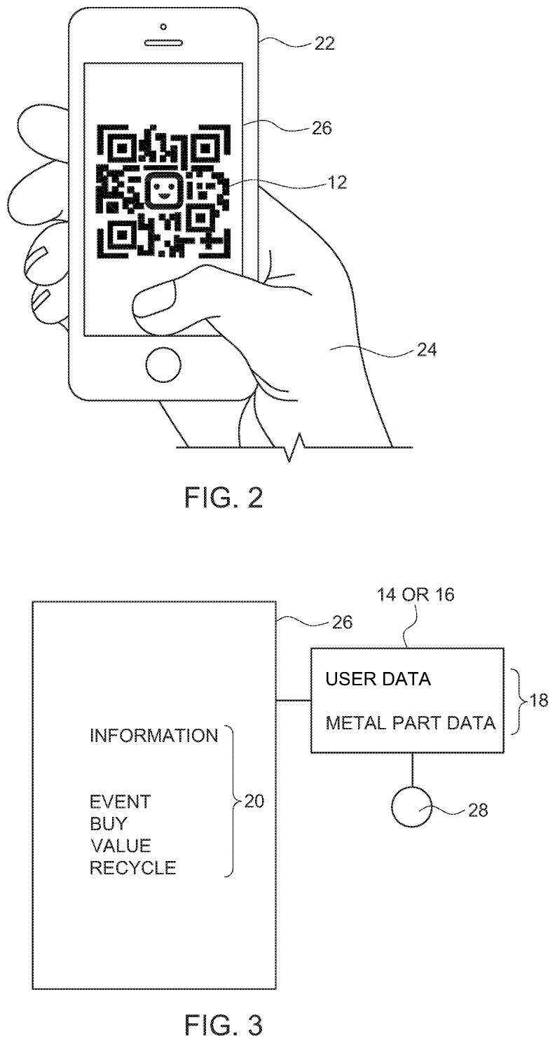

As shown in FIGS. 2 and 3, a mobile communication device 22 includes an optical reader (not shown) configured to scan the QR code 12 and a display screen 26 configured to display the information 20 (FIG. 3) and the data 18 (FIG. 3). Exemplary mobile communication devices include cell phones, iPads and computers having an optical function and supporting software. The mobile communication device 22 is in signal communication through suitable software with the online website 14 (FIG. 3) or the application 16 (FIG. 3) allowing the user 24 (particularly millennials) to manipulate the mobile communication device 22 to access the information 20 (FIG. 3) and the data 18 (FIG. 3) using techniques that are known in the art of mobile communication devices. The mobile communication device 22 is also in signal communication with a recycling entity 28 configured to control the information 20 (FIG. 3), to access the data 18 (FIG. 3) and to recycle the metal part 10 (FIGS. 1A-1B). An exemplary recycling entity 28 comprises MolyWorks Materials Corporation of Los Gatos, Calif.

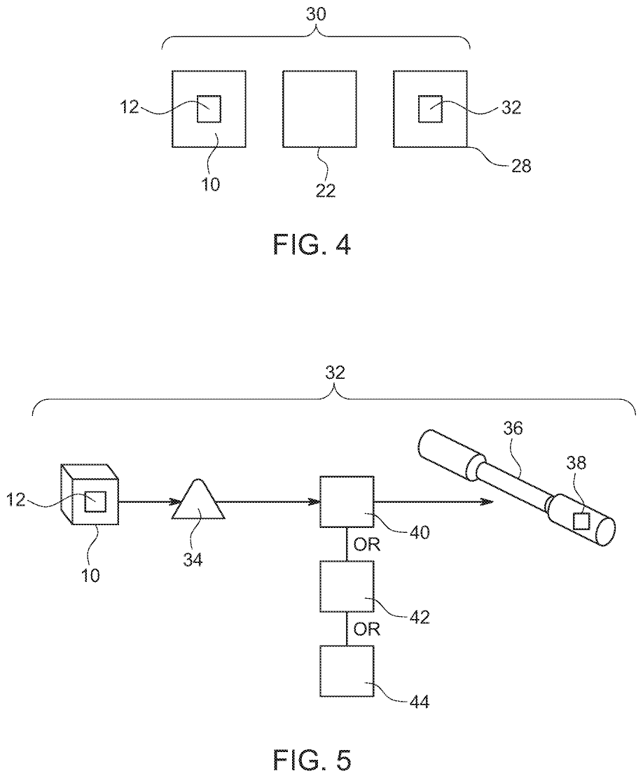

Referring to FIGS. 4 and 5, a recycling system 30 for recycling metal parts is represented schematically and includes the metal part 10 having the QR code 12 containing data on the metal part 10. The recycling system 30 also includes the mobile communication device 22 configured to read the QR code 12 and having a link to an online website or an application containing information on recycling the metal part 10. The recycling system 30 also includes the recycling entity 28 configured to control the information, to access the data and to recycle the metal part 10. In an illustrative embodiment the recycling system 30 also includes an additive manufacturing system 32 (FIG. 5) configured to melt the metal part 10 into a molten metal, to atomize the molten metal into an alloy powder 34 (FIG. 5), and to fabricate a recycled metal part 36 (FIG. 5) using the alloy powder 34. The recycled metal part 36 includes a second QR code 38 that is similar to the QR code 12 (FIG. 1A-1B) but with data specific to the recycled metal part 36. As shown, in FIG. 5, the additive manufacturing system 32 can utilize a laser powder bed fusion (LPBF) system 40, a laser metal deposition (LMD) system 42 or an electron beam melting (EBM) system 44.

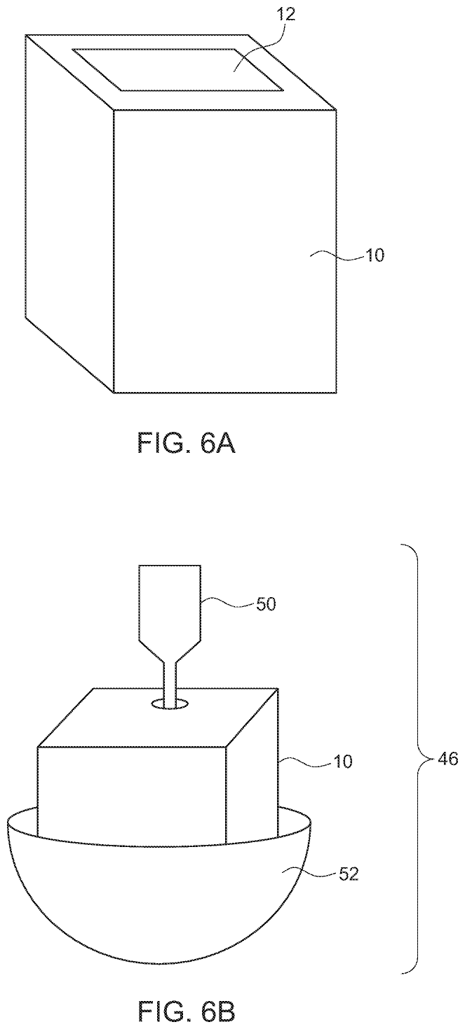

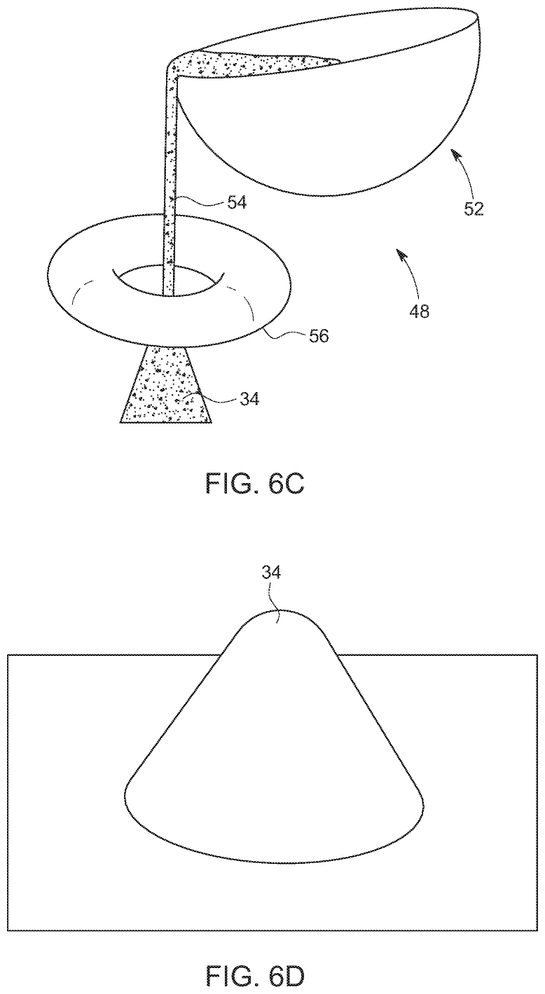

Referring to FIGS. 6A-6D, a cold hearth mixing system 46 (FIG. 6B) for melting the metal part 10 (FIG. 6A) and an atomization system 48 (FIG. 6C) for making the alloy powder 34 (FIG. 6D) are illustrated. As shown in FIG. 6B, the cold hearth mixing system 46 includes a heat source 50, such as a torch, and a mixing cold hearth 52. As shown in FIGS. 6B and 6C, during a cold hearth mixing process, the heat source 50 and the mixing cold hearth 52 are operated to produce a molten metal 54 (FIG. 6C) having a uniform composition, with composition correction performed if necessary. As shown in FIG. 6C, an atomization process can be performed using a gas atomizer 56 to form the alloy powder 34. U.S. Pat. No. 9,925,591 B2, which is incorporated herein by reference, discloses exemplary cold hearth mixing systems and exemplary gas atomization systems.

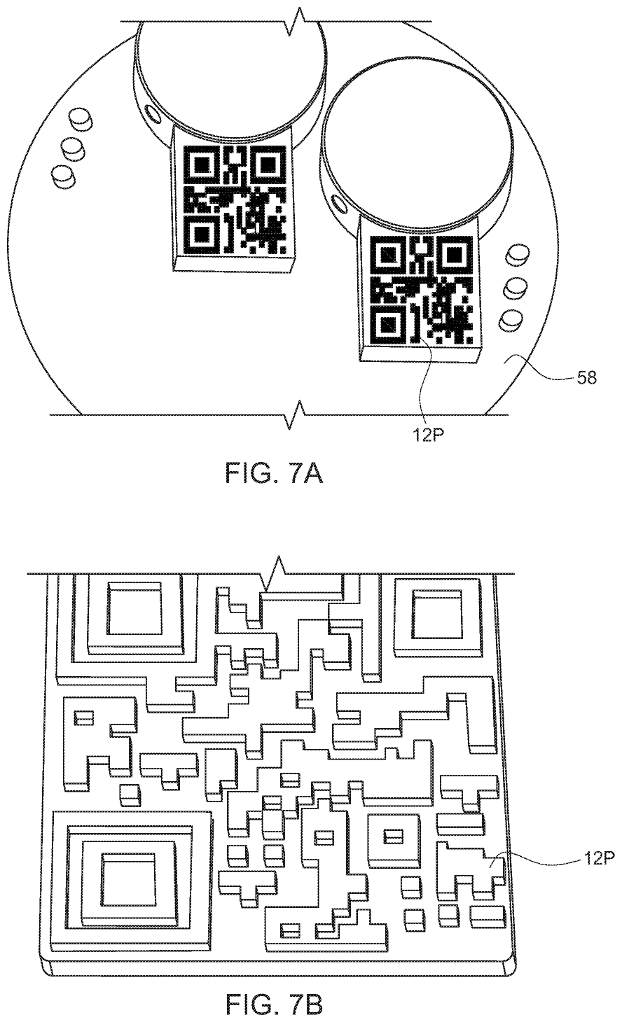

Referring to FIGS. 7A-7B, a second recycled metal part 58 has a generally cylindrical shape formed using an additive manufacturing system 32 (FIG. 5) that includes a 3-D printer such as a modified EOS M100 3D-Printer manufactured by EOS GmbH Electro Optical Systems. The second recycled metal part 58 includes a second QR code 12P which as shown in FIG. 7B is printed into the surface in the manner of vertical canyons which are then colored with a dye or paint.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A method for recycling metal parts comprising:
providing a metal part with a QR code linked to an online website or an application, the QR code containing data on the metal part and the website or the application containing information on recycling of the metal part;
reading the QR code using a mobile communication device enabling access to the information on the website or the application by a user of the mobile communication device and access to the data on the metal part by a recycling entity in signal communication with the website or the application configured to control the information and to recycle the metal part;
displaying selected information from the website or the application on the mobile communication device; and
recycling the metal part using at least some of the information on the website or the application and the data on the metal part.

2. The method of claim 1 wherein the recycling step comprises manufacturing a recycled metal part using metal from the metal part, the recycled metal part having a second QR code containing second data.

3. The method of claim 2 wherein the manufacturing step is performed using an additive manufacturing system.

4. The method of claim 1 further comprising contacting the user using contact information obtained from the mobile communication device during the reading step.

5. A method for recycling metal parts comprising:
providing a metal part with a QR code linked to an online website or an application, the QR code containing data on the metal part and the website or the application containing information on recycling of the metal part;
reading the QR code using a mobile communication device enabling access to the information on the website or the application by a user of the mobile communication device and access to the data on the metal part by a recycling entity in signal communication with the website or the application configured to control the information and to recycle the metal part;
displaying selected information from the website or the application on the mobile communication device; and
manufacturing a recycled metal part using metal from the metal part, the recycled metal part having a second QR code with second data.

6. The method of claim 5 wherein the manufacturing step is performed using an additive manufacturing system.

7. The method of claim 6 wherein the additive manufacturing system includes a laser powder bed fusion (LPBF) system, a laser metal deposition (LIVID) system, or an electron beam melting (EBM) system.

8. The method of claim 7 wherein the second QR code extends vertically into a surface of the recycled metal part.

9. A recycling system for recycling metal parts comprising:
a metal part having a QR code containing data on the metal part;
a mobile communication device configured to read the QR code and having a link to an online website or an application containing information on recycling the metal part; and
a recycling entity configured to control the information, to access the data and to recycle the metal part.

10. The recycling system of claim 9 wherein the recycling entity includes an additive manufacturing system configured to melt the metal part into a molten metal, to atomize the molten metal into an alloy powder, and to fabricate a recycled metal part using the alloy powder.

11. The recycling system of claim 10 wherein the additive manufacturing system includes a laser powder bed fusion (LPBF) system, a laser metal deposition (LIVID) system, or an electron beam melting (EBM) system.
